(19) United States
(12) Patent Application Publication
(10) Pub. No.: US 2020/0167414 A1
(43) Pub. Date: May 28, 2020

(54) WEBFORM GENERATION AND POPULATION

(71) Applicant: CITRIX SYSTEMS, INC., Fort Lauderdale, FL (US)

(72) Inventor: Jeroen Mattijs Van Rotterdam, Fort Lauderdale, FL (US)

(21) Appl. No.: 16/202,333

(22) Filed: Nov. 28, 2018

(51) Int. Cl. G06F 17/24; G06F 3/0481; G06F 17/27; G06F 3/0484

(52) U.S. Cl. CPC G06F 17/243; G06F 3/0481; G06F 17/246; G06F 3/0484; G06F 17/27

(57) ABSTRACT

A client computing device includes a display, an embedded browser and a processor. The embedded browser accesses a web application that requires data to be entered by a user. The processor cooperates with the embedded browser to display on the display a web page from the web application, with the web page including a form requiring data to be entered by the user. The form is analyzed by the processor to generate an overlay, with the overlay being separate from the web application. The processor is further configured to display the overlay over the form to assist with the user entering the required data, collect the data entered by the user into the overlay, and populate the form on the displayed web page based on the collected data.

### TECHNICAL FIELD

The present disclosure relates to web applications, and more particularly, to a web application requiring data to be entered by a user into a webform.

### BACKGROUND

Many web applications include webforms that allow data to be entered by a user. Most forms in these web applications offer a sub-optimal experience.

For example, a large number of new customers are to be entered into a web-based customer database application. Each customer data is individually entered by the user. This can become a time consuming process even if there is shared date, such as city and state, between the customers. Consequently, there is a need to improve user experience when entering data into webforms.

### SUMMARY

A client computing device includes a display, an embedded browser for accessing a web application requiring data to be entered by a user, and a processor cooperating with the embedded browser to display on the display a web page from the web application. The web page includes a form requiring data to be entered by the user. The form is analyzed to generate an overlay, with the overlay being separate from the web application. The overlay is displayed over the form to assist with the user entering the required data. The data entered by the user into the overlay is collected, and the form on the displayed web page is populated based on the collected data.

The overlay advantageously adds functionality to the web application without modifying the web application. This provides a more pleasant user experience when entering data into webforms.

Analyzing the form by the processor includes determining what kind of data is to be entered by the user, and determining what constraints are included within the form. The processor incorporates the constraints into the overlay.

Analyzing the form may further include determining if the form has existing data already entered, and if so, then include the existing data into the overlay.

Analyzing the form is in response to user input. A cursor on the display is to be placed over the form by the user before the user provides the user input to analyze the form.

The client computing device may further include an application, with the application being accessed to provide the overlay. The overlay, for example, may be spreadsheet for entry of text data, and a map for entry of location data. The overlay is not limited to spreadsheets and maps and may include other types to assist a user entering data into webform.

Another aspect is directed to a method for operating a client computing device as described above. The method includes operating the embedded browser to access a web application that requires data to be entered by a user, and operating the processor cooperating with the embedded browser to display on the display a web page from the web application. The web page includes a form requiring data to be entered by the user. The form is analyzed to generate an overlay, with the overlay being separate from the web application. The overlay is displayed over the form to assist with the user entering the required data. The data entered by the user into the overlay is collected, and the form on the displayed web page is populated based on the collected data.

Yet another aspect is directed to a non-transitory computer readable medium for operating a client computing device as described above, and with the non-transitory computer readable medium having a plurality of computer executable instructions for causing the client computing device to perform steps as described above.

### BRIEF DESCRIPTION OF THE DRAWINGS

FIG. 1 is a block diagram of a network environment of computing devices in which various aspects of the disclosure may be implemented.

FIG. 2 is a block diagram of a computing device useful for practicing an embodiment of the client machines or the remote machines illustrated in FIG. 1.

FIG. 3 is a block diagram of a computing system that includes a client computing device with an embedded browser that generates an overlay for webforms in which various aspects of the disclosure may be implemented.

FIG. 4 is an example screen shot of the web page illustrated in FIG. 3 that includes a webform requiring new customer data to be entered by a user.

FIG. 5 is a screen shot of the webform illustrated in FIG. 4 with an overlay to assist the user in entering the new customer data into the webform.

FIG. 6 is another example screen shot of the web page illustrated in FIG. 3 that includes a webform requiring location data to be entered by a user.

FIG. 7 is a screen shot of the webform illustrated in FIG. 6 with an overlay to assist the user in entering the location data into the webform.

FIG. 8 is a general flowchart illustrating a method for operating the client computing device illustrated in FIG. 3.

FIG. 9 is a more detailed flowchart illustrating a method for operating the client computing device illustrated in FIG. 3.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

As will be appreciated by one of skill in the art upon reading the following disclosure, various aspects described herein may be embodied as a device, a method or a computer program product (e.g., a non-transitory computer-readable medium having computer executable instruction for performing the noted operations or steps). Accordingly, those aspects may take the form of an entirely, hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

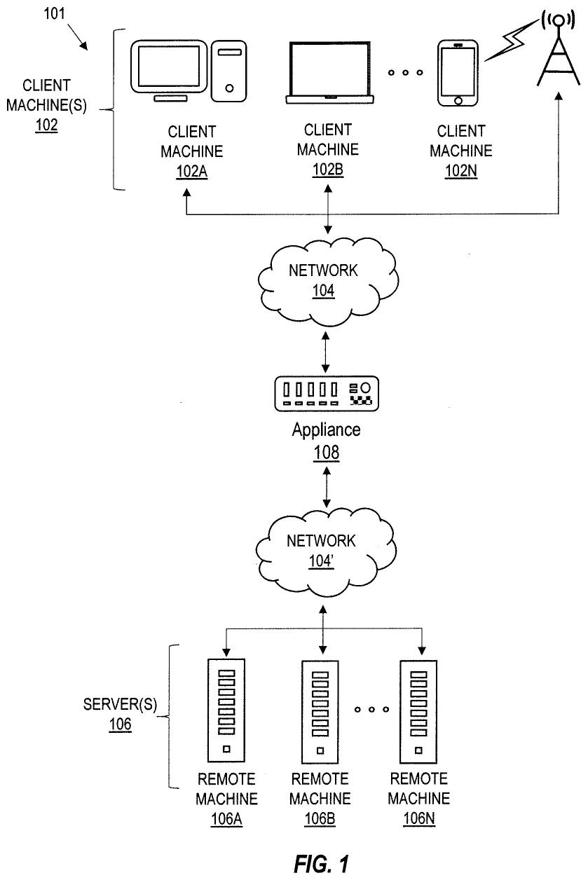

Referring initially to FIG. 1, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation client or other client or program that uses a thin-client or a remote-display protocol to capture display output generated by an application executing on a server 106 and transmits the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a WLAN, the protocols may include 802.11, Bluetooth, and Near Field Communication (NFC).

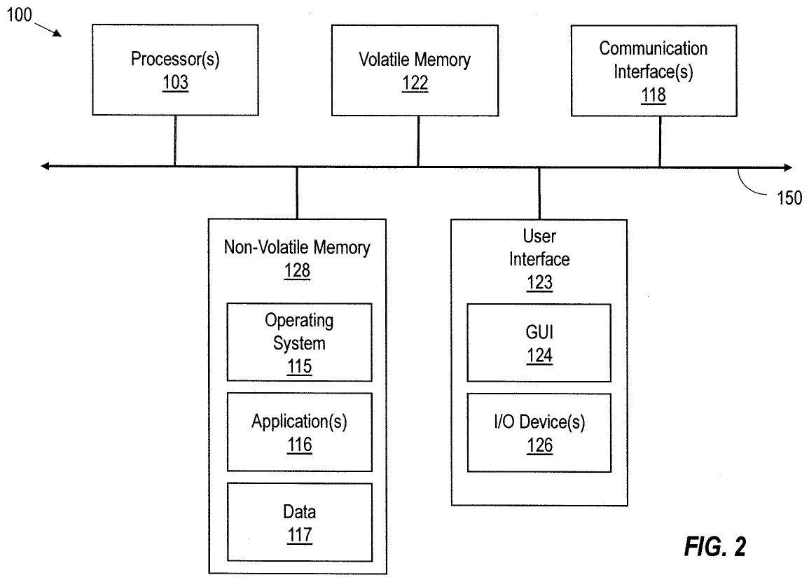

FIG. 2 depicts a block diagram of a computing device 100 useful for practicing an embodiment of client devices 102 or servers 106. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid state storage media; one or more hybrid magnetic and solid state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor may be analog, digital or mixed-signal. In some embodiments, the processor may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

Additional descriptions of a computing device 100 configured as a client device 102 or as a server 106, or as an appliance intermediary to a client device 102 and a server 106, and operations thereof, may be found in U.S. Pat. Nos. 9,176,744 and 9,538,345, which are incorporated herein by reference in their entirety. The '744 and '345 patents are both assigned to the current assignee of the present disclosure.

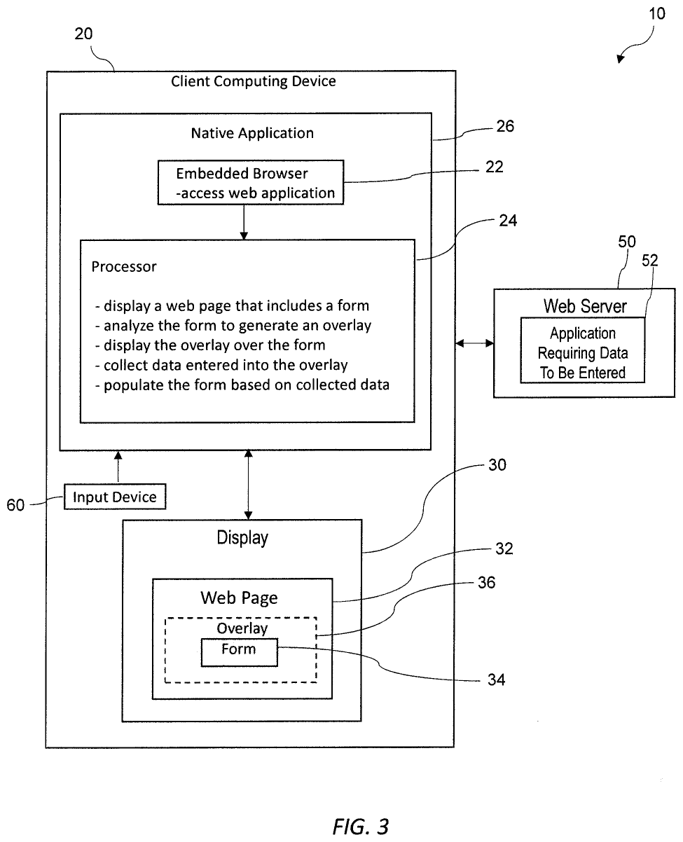

Referring initially to FIG. 3, a computing system 10 includes a client computing device 20 and a web server 50. As will be discussed in detail below, the client computing device 20 generates an overlay 36 for a webform 34 to assist a user in entering data into the webform 34. The overlay 36 is not part of the web application 52 providing the webform 34. A webform 34 may also be referred to as a form 34.

Most forms 34 within web applications 52 offer a sub-optimal experience when data is to be entered. These web applications 52 typically do not offer assistance to the user when entering data into the forms 34. The overlays 36 are generated separate from the web applications 52 so as to enhance the user interface experience of the user when entering data into the forms 34.

The client computing device 20 includes a display 30, an embedded browser 22 and a processor 24. The embedded browser 22 accesses a web application 52 requiring data to be entered by a user. The web application 52 is from the web server 50. The web application 52 may be a Software as a Service (SaaS) application, for example.

The processor 24 cooperates with the embedded browser 22 to display on the display 30 a web page 32 from the web application 52. The web page 32 includes the form 34 requiring data to be entered by the user. The processor 24 analyzes the form 34 to generate the overlay 36. The overlay 36 is not part of the web application 52 and is generated separate from the web application 52.

The processor 24 displays the overlay 36 over the form 34 to assist with the user entering the required data, collects the data entered by the user into the overlay 36, and populates the form 34 on the displayed web page 32 based on the collected data. The overlay 36 may be in the form of a spreadsheet, for example, to assist the user in entering data. The spreadsheet, for example, is particularly useful when a large amount of data is to be entered into the form 34 since repeat data can be copied for other data entries instead of having to be separately typed in each time by the user.

The embedded browser 22 is a browser embedded within a native application 26. For example, Citrix Receiver and Citrix Workspace App are native applications that may be installed on client computing devices 20.

Since the embedded browser 22 is embedded within the native application 26, this allows the user interface of the web application 52 to be enhanced without modifying the web application 52 itself. Instead, logic outside of the embedded browser 22 allows the native application 26 to control the processor 24 so as to analyze the form 34 to generate the overlay 36, display the overlay 36 over the form 34, collect the data entered by the user into the overlay 36, and populate the form 34 on the displayed web page 32 based on the collected data.

The client computing device 20 includes an input device 60. The input device 60 may be a keyboard or a pointing device, for example. When the user is ready to enter data into the displayed form 34, a cursor is positioned within the form 36. The user then selects an advanced UI control 62 that is displayed along with the form 34(1) to activate the processor 24 to analyze the form 34(1), as illustrated in FIG. 4. The advanced UI control 62 may be in the form of a hot button or a drop down menu selection, for example.

After selection of the advanced UI control 62, the processor 24 analyzes the form 34(1) from the displayed web page 32(1). The form 34(1) may be an HTML form, for example. By analyzing the HTML form 34(1), the processor 24 can determine the areas requiring data entry, as well as what kind of data is to be entered.

In the example provided in FIG. 4, addresses for new customers are to be entered in text boxes. Each address includes the customer's name, street, zip code and city. Without the overlay 36(1) the user would enter the address and then select the add data symbol 64. The user would repeat these steps for each customer. Even if a majority of the new customers have the same city, the user has to retype “Fort Lauderdale” for each of these customers. Consequently, the user does not have a pleasant user experience when having to repeatedly type in the same information for different customers.

When the HTML form 34(1) is analyzed, there may be constraints associated with the data to be entered. The constraints may determine how the data is to be entered, such as with a text box, drop down menu, or a lookup, for example. The constraints may also include data validation rules. The data validation rules insure that valid data is entered by the user. For example, the data validation rules would not permit a non-existent zip code to be entered. An error message would be returned for an invalid data entry.

In addition, the web application 52 may have existing customer data that has been previously entered by the user. This information would be included in the overlay 36(1).

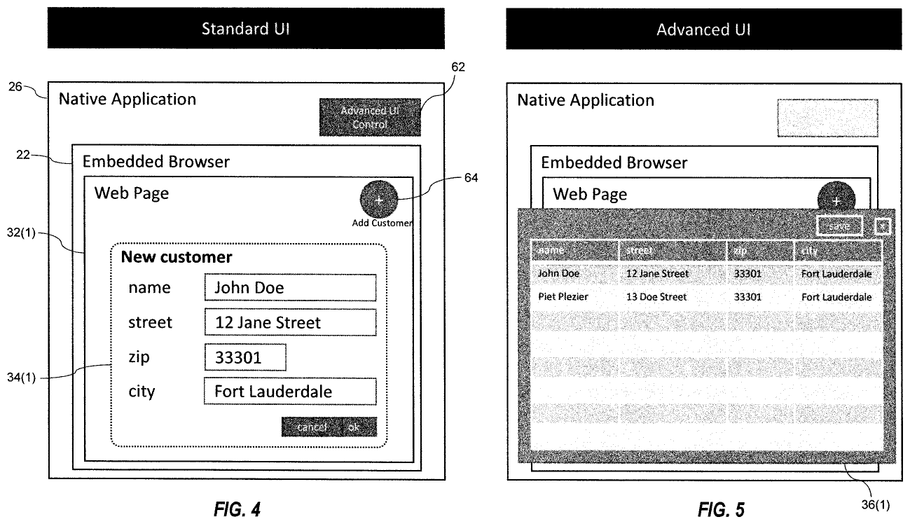

After the form 34(1) has been analyzed, an overlay 36(1) is displayed over the form 34(1), as illustrated in FIG. 5. In this example, the overlay 36(1) is in the form of a spreadsheet. The spreadsheet is provided by an application stored on the client computing device 20, such as Microsoft Excel. In other embodiments, the spreadsheet is provided by another web application accessed by the embedded browser 22.

The overlay 36(1) allows the user to enter at one time all of the addresses for the new customers. With the use of a spreadsheet as the overlay 36(1), the user can block copy shared data entries to other customers. In this example, the user can copy the zip code and city data entries from the first customer to different customer. This provides a more pleasant user experience when a large amount of data is to be repeatedly entered.

The processor 24 collects the address data entered by the user into the overlay 36(1), and populates the form 34(1) on the displayed web page 32(1) based on the collected address data. The overlay 36(1) advantageously adds functionality to the web application 52 without modifying the web application 52.

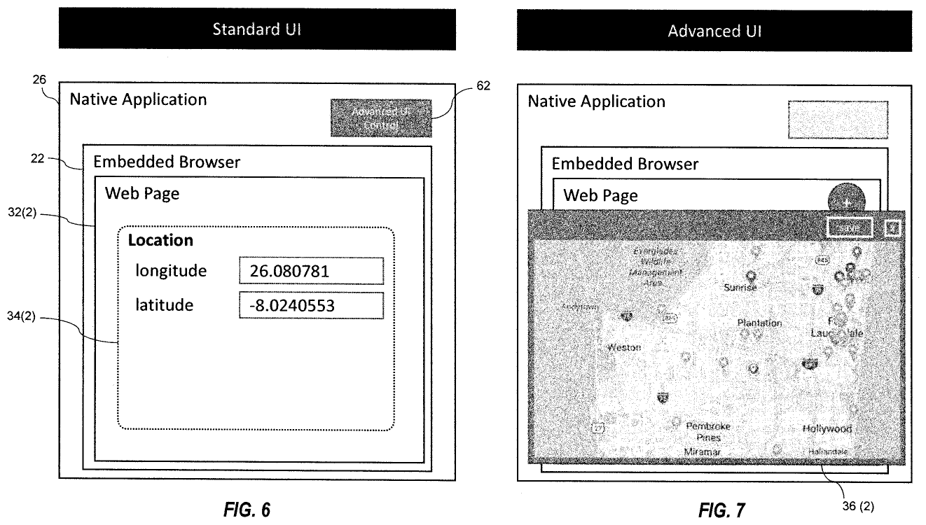

As another example for data entry, reference is now directed to FIGS. 6 and 7. In this example, location data is to be entered into a form 34(2).

After selection of the advanced UI control 62, the processor 24 analyzes the form 34(2) from the displayed web page 32(2). By analyzing the form 34(2), the processor 24 can determine the areas requiring data entry, as well as what kind of data is to be entered.

In the example provided in FIG. 6, location data is to be entered. Longitude and latitude are to be entered in text boxes. Without the overlay 36(2) the user would have to know ahead of time the longitude and latitude to enter. If the user does not know this information ahead of time, the user will have to look it up. Consequently, the user does not have a pleasant user experience.

After the form 34(2) has been analyzed, the overlay 36(2) is displayed over the form 34(2), as illustrated in FIG. 7. In this example, the overlay 36(2) is in the form of a map. The map is provided by an application stored on the client computing device 20, such as Google Maps. In other embodiments, the map is provided by another web application accessed by the embedded browser 22.

The overlay 36(2) allows the user to select the desired location on a map. After the location has been selected, the processor 24 collects the longitude and latitude from the map for the selected location. The processor 24 then populates the form 34(2) on the displayed web page 32(2) based on the collected longitude and latitude. The overlay 36(2) advantageously adds functionality to the web application 52 without modifying the web application 52. This provides a more pleasant user experience.

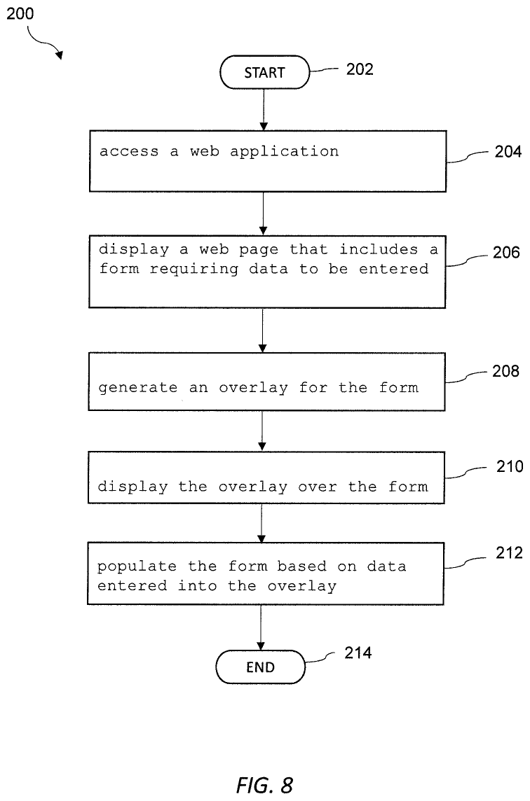

The overlays 36(1) and 36(2) as discussed above are for illustrative purposes and are not to be limiting. The overlays 36 are not limited to spreadsheets and maps and may include other types to assist a user entering data into webform. Referring now to the flowchart 200 in FIG. 8, and generally speaking, a method for operating a client computing device will be discussed. From the start (Block 202), the method includes accessing a web application 52 at Block 204, and displaying a web page 40 at Block 206 that includes a form 34 requiring data to be entered. An overlay 36 is generated for the form 34 at Block 208, and the overlay 36 is displayed over the form 34 at Block 210. The form 34 is populated based on data entered into the overlay 36 at Block 212. The method ends at Block 214.

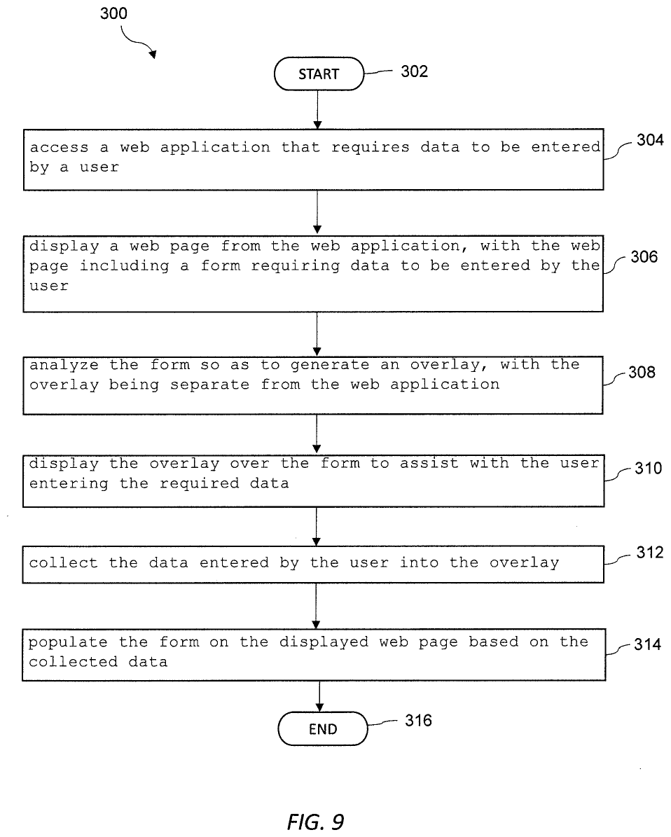

Referring now to the flowchart 300 in FIG. 9, more detailed steps for operating a client computing device 20 comprising a display 30, an embedded browser 22 and a processor 24 will be discussed. From the start (Block 302), the method includes operating the embedded browser 22 at Block 304 to access a web application 52 that requires data to be entered by a user.

The processor 24 is operated to cooperate with the embedded browser 22 to display a web page 32 from the web application 52 at Block 306. The web page 32 includes a form 34 requiring data to be entered by the user.

The form 34 is analyzed to generate an overlay 36 at Block 308, with the overlay 36 being separate from the web application 52. The overlay 36 is displayed over the form 34 at Block 310 to assist with the user entering the required data. The data entered by the user into the overlay 36 is collected at Block 312, and the form 34 on the displayed web page 32 is populated at Block 314 based on the collected data. The method ends at Block 316.

Another aspect is directed to a non-transitory computer readable medium for operating a client computing device 20 comprising a display 30, an embedded browser 22 and a processor 24, and with the non-transitory computer readable medium having a plurality of computer executable instructions for causing the client computing device to perform steps that includes operating the embedded browser 22 to access a web application 52 that requires data to be entered by a user, and operate the processor 24 to cooperate with the embedded browser 22 to display a web page 32 from the web application 52. The web page 32 includes a form 34 requiring data to be entered by the user. The form 34 is analyzed to generate an overlay 36, with the overlay 36 being separate from the web application 52. The overlay 36 is displayed over the form 34 to assist with the user entering the required data. The data entered by the user into the overlay 36 is collected, and the form 34 on the displayed web page 32 is populated based on the collected data.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed:

1. A client computing device comprising:
a display;
an embedded browser for accessing a web application requiring data to be entered by a user; and
a processor cooperating with the embedded browser to perform the following:
display on said display a web page from the web application, with the web page including a form requiring data to be entered by the user,
analyze the form to generate an overlay, with the overlay being separate from the web application,
display the overlay over the form to assist with the user entering the required data,
collect the data entered by the user into the overlay, and
populate the form on the displayed web page based on the collected data.

2. The client computing device according to claim 1 wherein analyzing the form by said processor comprises:
determine what kind of data is to be entered by the user; and
determine what constraints are included within the form.

3. The client computing device according to claim 2 wherein said processor incorporates the constraints into the overlay.

4. The client computing device according to claim 1 wherein analyzing the form by said processor comprises:
determine if the form has existing data already entered, and if so, then include the existing data into the overlay.

5. The client computing device according to claim 1 wherein analyzing the form by said processor is in response to user input.

6. The client computing device according to claim 5 wherein a cursor on said display is to be placed over the form by the user before the user provides the user input to analyze the form.

7. The client computing device according to claim 1 further comprising an application, and wherein said processor accesses the native application to provide the overlay.

8. The client computing device according to claim 1 wherein the overlay comprises at least one of a spreadsheet and a map.

9. The client computing device according to claim 1 wherein the web application comprises a Software as a Service (SaaS) application.

10. A method for operating a client computing device comprising a display, an embedded browser and a processor, the method comprising:
operating the embedded browser to access a web application that requires data to be entered by a user; and
operating the processor cooperating with the embedded browser to perform the following:
displaying on the display a web page from the web application, with the web page including a form requiring data to be entered by the user,
analyzing the form to generate an overlay, with the overlay being separate from the web application,
displaying the overlay over the form to assist with the user entering the required data,
collecting the data entered by the user into the overlay, and
populating the form on the displayed web page based on the collected data.

11. The method according to claim 10 wherein analyzing the form by the processor comprises:
determining what kind of data is to be entered by the user; and
determining what constraints are included within the form.

12. The method according to claim 11 wherein the processor incorporates the constraints and the data validation rules into the overlay.

13. The method according to claim 10 wherein analyzing the form by the processor comprises:
determining if the form has existing data already entered, and if so, then include the existing data into the overlay.

14. The method according to claim 10 wherein analyzing the form by the processor is in response to user input.

15. The method according to claim 14 wherein a cursor on the display is to be placed over the form by the user before the user provides the user input to analyze the form.

16. The method according to claim 10 wherein the client computing device further comprises an application, and wherein the processor accesses the application to provide the overlay.

17. A non-transitory computer readable medium for operating a client computing device comprising a display, an embedded browser and a processor, and with the non-transitory computer readable medium having a plurality of computer executable instructions for causing the client computing device to perform steps comprising:
operating the embedded browser to access a web application that requires data to be entered by a user; and
operating the processor cooperating with the embedded browser to perform the following:
displaying on the display a web page from the web application, with the web page including a form requiring data to be entered by the user,
analyzing the form to generate an overlay, with the overlay being separate from the web application,
displaying the overlay over the form to assist with the user entering the required data,
collecting the data entered by the user into the overlay, and
populating the form on the displayed web page based on the collected data.

18. The non-transitory computer readable medium according to claim 17 wherein analyzing the form by the processor comprises:
determining what kind of data is to be entered by the user; and
determining what constraints are included within the form.

19. The non-transitory computer readable medium according to claim 18 wherein the processor incorporates the constraints into the overlay.

20. The non-transitory computer readable medium according to claim 17 wherein analyzing the form by the processor comprises:
determining if the form has existing data already entered, and if so, then include the existing data into the overlay.
